(19) United States
(12) Patent Application Publication
(10) Pub. No.: US 2021/0332845 A1
(43) Pub. Date: Oct. 28, 2021

(54) FLEXIBLE HINGE STRUCTURE

(71) Applicant: The Institute of Optics and Electronics, The Chinese Academy of Sciences, Chengdu, Sichuan (CN)

(72) Inventors: Taotao FU, Chengdu, Sichuan (CN); Yun LI, Chengdu, Sichuan (CN)

(73) Assignee: The Institute of Optics and Electronics, The Chinese Academy of Sciences, Chengdu, Sichuan (CN)

(21) Appl. No.: 16/626,745

(22) PCT Filed: Dec. 27, 2018
(86) PCT No.: PCT/CN2018/124456

§ 371 Date: Dec. 26, 2019

(30) Foreign Application Priority Data
Nov. 26, 2018 (CN) 201811415219.2

(51) Int. Cl. F16C 11/12

(52) U.S. Cl. CPC F16C 11/12; G03B 2205/0046

(57) ABSTRACT

The present disclosure provides a flexible hinge structure including: a rigid driving member; a mounting fixed member which is connected to an upper surface of the rigid driving member through a first flexible portion at one end in a longitudinal direction of the upper surface, a first fixing structure being provided on a surface of the mounting fixed member; a displacement output member connected to the upper surface of the rigid driving member through a second flexible portion at the other end in the longitudinal direction of the upper surface; and a pair of guiding fixed members symmetrically disposed on both sides of the displacement output member through third flexible portions, the both sides being parallel to the longitudinal direction of the upper surface of the rigid driving member and a second fixing structure being provided on a surface of each of the guiding fixed members.

### TECHNICAL FIELD

The present disclosure relates to the field of precision micro-transmission technologies, in particular to a flexible hinge structure.

### BACKGROUND

In precision optical systems, a case where an output direction and a driving direction form an angle of 90 degrees is generally encountered. Especially in optical exposure systems, a moving mirror is adjusted with a small displacement, which is usually only a few micrometers or even less, thus it is urgent to design a high-precision micro-displacement structure to meet the transmission of 90 degrees in the precision system.

### SUMMARY

### (1) Technical Problems to be Solved

At least the above technical problems are solved by a flexible hinge structure of the present disclosure.

### (2) Technical Solutions

The present disclosure provides a flexible hinge structure comprising: a rigid driving member 3; a mounting fixed member 1 which is connected to an upper surface of the rigid driving member 3 through a first flexible portion 11 at one end in a longitudinal direction of the upper surface, a first fixing structure 100 being provided on a surface of the mounting fixed member 1; a displacement output member 2 connected to the upper surface of the rigid driving member 3 through a second flexible portion 21 at the other end in the longitudinal direction of the upper surface; and a pair of guiding fixed members 4 symmetrically disposed on both sides of the displacement output member 2 through third flexible portions 41, the both sides being parallel to the longitudinal direction of the upper surface of the rigid driving member 3 and a second fixing structure 400 being provided on a surface of each of the guiding fixed members 4.

Optionally, wherein the mounting fixed member 1 is composed of at least one first rigid block, the at least one first rigid block are connected to one another through a fourth flexible portion 12, and the first fixing structure 100 is disposed on a surface of an outermost first rigid block.

Optionally, the displacement output member 2 is composed of at least two second rigid blocks, and the second rigid blocks are connected to one another through a fifth flexible portion 22.

Optionally, each of the guiding fixed members 4 is composed of at least two third rigid blocks, the third rigid blocks are connected to one another through a sixth flexible portion 42, and the second fixing structure 400 is disposed on a surface of an outermost third rigid block.

Optionally, the first flexible portion 11, the second flexible portion 21, the fourth flexible portion 12, and the fifth flexible portion 22 are parallel to each other.

Optionally, a longitudinal direction of each of the first flexible portion 11, the second flexible portion 21, the fourth flexible portion 12 and the fifth flexible portion 22 is perpendicular to a longitudinal direction of the mounting fixed member 1.

Optionally the sixth flexible portion 42 is parallel to the third flexible portion 41.

Optionally, a longitudinal direction of each of the sixth flexible portion 42 and the third flexible portion 41 is parallel to a longitudinal direction of the mounting fixed member 1.

Optionally, each of the first flexible portion 11, the second flexible portion 21, the third flexible portion 41, the fourth flexible portion 12, the fifth flexible portion 22 and the sixth flexible portion 42 has a cross section of an I-shape or a circular arc shape.

Optionally, each of the first fixing structure 100 and the second fixing structure 400 comprises at least a mounting hole.

### (3) Beneficial Effects

The present disclosure provides a flexible hinge structure, wherein a drive block is connected to a displacement block by 90 degrees through a flexible portion. Since the flexible portion is elastically deformable, a displacement in the output direction is at an angle of 90 degrees relative to a displacement in the driving direction. There is no linkage mechanism for transmitting force in the structure, and a driving member is directly connected to a displacement output member through the flexible portion, therefore, the structure is compact and the response is fast.

### BRIEF DESCRIPTION OF THE DRAWINGS

FIG. 1 schematically shows a perspective view of a flexible hinge structure according to an embodiment of the present disclosure;

FIG. 2 is a schematic front view of the flexible hinge structure shown in FIG. 1 according to an embodiment of the present disclosure;

FIG. 3 is a schematic rear view of the flexible hinge structure shown in FIG. 1 according to an embodiment of the present disclosure;

FIG. 4 is a schematic front view of the flexible hinge structure shown in FIG. 1 after being displaced by force, according to an embodiment of the disclosure;

FIG. 5 is a schematic rear view of the flexible hinge structure corresponding to FIG. 4 after being displaced by force, according to an embodiment of the disclosure; and

FIG. 6 is a schematic view showing the proportional relationship between a displacement amount of a driving member and a displacement amount of an output member in the flexible hinge structure according to an embodiment of the present disclosure.

### EXPLANATION OF THE REFERENCE NUMBERS

1—mounting fixed member;
11—first flexible portion;
12—fourth flexible portion;
100—first fixing structure on the mounting fixed member 1;
2—displacement output member;
21—second flexible portion;
22—fifth flexible portion;
3—rigid driving member;
4—guiding fixed member;
41—third flexible portion connected to the guiding fixed member 4;
42—sixth flexible portion;
400—second fixing structure on the guiding fixed member 4.

### DETAILED DESCRIPTION OF THE EMBODIMENTS

The present disclosure provides a flexible hinge structure, comprising: a rigid driving member 3; a mounting fixed member 1 which is connected to an upper surface of the rigid driving member 3 through a first flexible portion 11 at one end in a longitudinal direction of the upper surface, a first fixing structure 100 being provided on a surface of the mounting fixed member 1; a displacement output member 2 which is connected to the upper surface of the rigid driving member 3 through the second flexible portion 21 at the other end in the longitudinal direction of the upper surface; and a pair of guiding fixed members 4 which are symmetrically disposed on both sides of the displacement output member 2 through third flexible portions 41, the both sides being parallel to the longitudinal direction of the upper surface of the rigid driving member 3, a second fixing structure 400 being provided on a surface of each of the guiding fixed members 4.

In order to make objects, technical solutions and advantages of the present disclosure more clear, the present disclosure will be further described in detail below with reference to specific embodiments and with reference to the accompanying drawings.

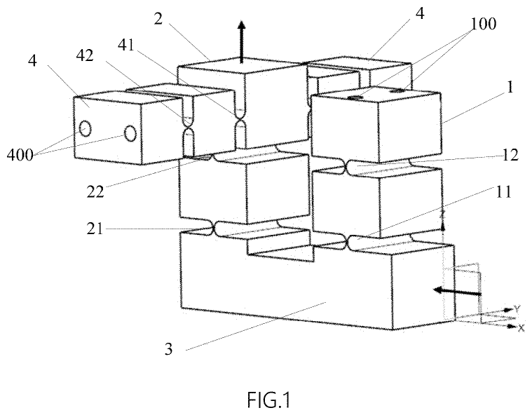

FIG. 1 schematically shows a perspective view of a flexible hinge structure according to an embodiment of the present disclosure. In order to describe the embodiments of the present disclosure well, the following will be described in a direction illustrated in FIG. 1. However, it should be noted here that the direction illustrated in FIG. 1 is only a schematic direction of the flexible hinge structure in this embodiment, and does not represent the installation direction in operation or in practical applications. The direction of the flexible hinge structure during operation or installation may be configured according to actual needs, and is not limited by the direction illustrated in FIG. 1.

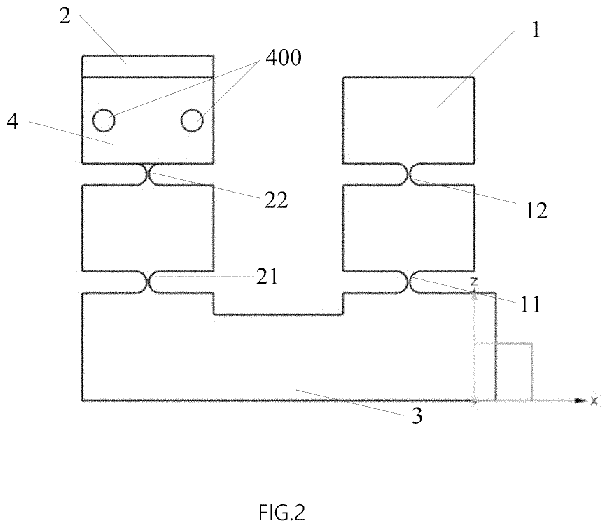

As shown in FIG. 1, the present disclosure comprises a mounting fixed member 1, a displacement output member 2, a rigid driving member 3 and a pair of guiding fixed members 4. The mounting fixed member 1 and the displacement output member 2 are respectively mounted on the same surface of the rigid driving member 3 at opposite ends, so that the mounting fixed member 1, the displacement output member 2 and the rigid driving member 3 form a U-shaped structure (as shown in FIG. 2). The guiding fixed members 4 are symmetrically mounted on both sides of the displacement output member 2 and perpendicular to the U-shaped structure. The mounting fixed member 1, the displacement output member 2, the rigid driving member 3 and the guiding fixed member 4 are connected through flexible portions. For ease of description, the structure is placed in a three-dimensional coordinate system. As shown in FIG. 1, the U-shaped plane is located in the xz plane, and the guiding fixed members 4 are perpendicular to the U-shaped structure as described above, that is, they are arranged in the z direction, and each structure will be specifically described below.

First, the rigid driving member 3 is a rigid block comprising at least two faces perpendicular to each other. One of the two faces is a force receiving surface. As shown in FIG. 1, the force receiving surface is located in the yz plane, and a direction of a force is perpendicular to the force receiving surface, that is, in a negative direction of the x-axis. The other one of the two faces is located in the xy plane and used for connecting the fixed member 1 and the displacement output member 2. In order to save materials or for design needs, a certain groove or the like may be provided in a portion of the other surface that is not connected to the flexible portion. Since the portion of the other surface does not relate to the flexible connecting portion of the present disclosure, the technical effects of the present disclosure are not affected, and the above scheme is within the protection scope of the present disclosure.

The mounting fixed member 1 is connected to one end of the rigid driving member 3 through a first flexible portion 11. The mounting fixed member 1 is composed of at least one first rigid block. When there is only one first rigid block, the mounting fixed member 1 is directly connected to the rigid driving member 3 through the first flexible portion 11. When the mounting fixed member 1 is composed of two first rigid blocks, the first rigid blocks are connected with each other through a fourth flexible portion 12. Similarly, when the number of the first rigid blocks constituting the mounting fixed member 1 is increased, the number of the fourth flexible portions 12 is also increased in proportion to the number of the first rigid blocks. And in order to ensure the consistency of the direction of the force (i.e., the direction of the degrees of freedom), the fourth flexible portion 12 constituting the mounting fixed member 1 is parallel to a mounting direction of the first flexible portion 11. Among the first rigid blocks constituting the mounting fixed member 1, the uppermost first rigid block (i.e., the outermost first rigid block which is farthest from the rigid driving member 3) is a fixed block. A first fixing structure 100 is provided on the uppermost first rigid block and used for connecting with an external fixing structure or device. The first fixing structure 100 may be a mounting hole as shown in FIG. 1 or a fixing protrusion, etc., any fixing structure capable of fixing the fixed block is within the protection scope of the present disclosure, and is not limited to the mounting hole shown in FIG. 1. Meanwhile, the above-described rigid blocks constituting the mounting fixed member 1 are preferably cubic blocks, and each face of each rigid block is parallel to a corresponding face of other rigid blocks.

The displacement output member 2 is connected to the other end of the rigid driving member 3 through a second flexible portion 21, and the displacement output member 2 is composed of at least two second rigid blocks. When the mounting fixed member is composed of two second rigid blocks as shown in FIG. 1, the second rigid blocks are connected with each other through a fifth flexible portion 22. When the number of the second rigid blocks constituting the displacement output member 2 is increased, the number of the fifth flexible portions 22 is also increased in proportion to the number of the second rigid blocks. And in order to ensure the consistency of the direction of the force (i.e., the direction of the degrees of freedom), the fifth flexible portion 22 constituting the displacement output member 2 is parallel to a mounting direction of the second flexible portion 21. The second rigid blocks constituting the displacement output member 2 are preferably a cube blocks, and each face of each cube block is parallel to a corresponding face of other cube blocks, and is parallel to a corresponding face of the above-described first rigid blocks constituting the mounting fixed member 1. The first flexible portion 11, the fourth flexible portion 12, the second flexible portion 21, and the fifth flexible portion 22 are all parallel to each other and a longitudinal direction thereof is preferably perpendicular to a longitudinal direction of the mounting fixed member 1 (i.e., the direction of the force applied to the force receiving surface), so that the first flexible portion 11, the fourth flexible portion 12, the second flexible portion 21, and the fifth flexible portion 22 may drive the connected rigid blocks to rotate about the Y axis under the action of the force. The second rigid block of the displacement output member 2 away from the rigid driving member 3 is a displacement output block which may transmit a slight displacement under the driving of the fifth flexible portion 22.

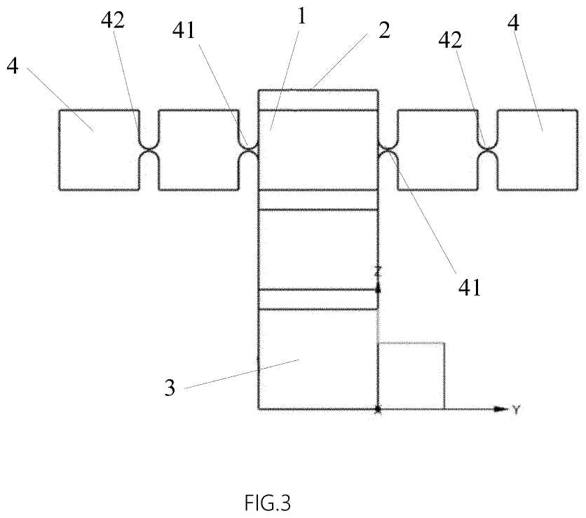

The pair of guiding fixed members 4 are composed of the same two parts, which are respectively symmetrically connected with the uppermost second rigid block of the displacement output member 2 through the third flexible portion 41 (as shown in FIG. 3), and each part is composed of at least two third rigid blocks. When each part is composed of two third rigid blocks, the two third rigid blocks are connected with each other through a sixth flexible portion 42, and a mounting direction of the third flexible portion 41 and a mounting direction of the sixth flexible portion 42 are parallel to each other, and are preferably parallel to the longitudinal direction of the mounting fixed member 1 (i.e., the direction of the force applied to the force receiving surface). The third rigid block of each guiding fixed member 4 away from the displacement output member 2 is a fixed block, and a second fixing structure 400 is disposed on the fixed block for connecting with an external fixing structure or device. The second fixing structure 400 may be a mounting hole as shown in FIG. 1 or a fixing protrusion, etc., any fixing structure capable of fixing the fixed block is within the protection scope of the present disclosure, and are not limited to the mounting hole shown in FIG. 1. Meanwhile, the above-described rigid blocks constituting the mounting fixed member 4 are preferably cubic blocks, and each face of each rigid block is parallel to a corresponding face of other rigid blocks.

The first flexible portion 11, the fourth flexible portion 12, the second flexible portion 21, the fifth flexible portion 22, the third flexible portion 41, and the sixth flexible portion 42 preferably have a circular arc shape formed by a wire cutting process or an I-shape. Their dimensions are as consistent as possible, and the stiffness of a flexible material of which the flexible portions are made is as uniform as possible. It should be emphasized here that the structures of the flexible portions in the present disclosure are not limited to the circular arc shape formed by a wire cutting process or an I-shape. Any structure capable of connecting the rigid block to rotate the rigid block about the Y axis is within the protection scope of the present disclosure.

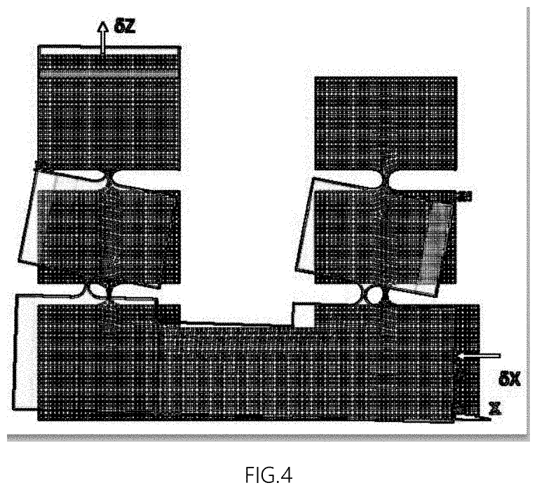

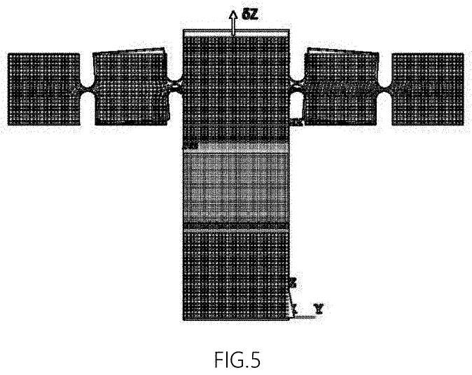

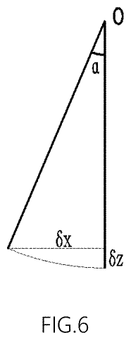

Through the above manner, the displacement deflection shown in FIG. 4 and FIG. 5 may be realized. After the force is applied, the mounting fixed member 1 and the displacement output member 2 are rotated about a direction perpendicular to the U-shaped plane under the driving of the rigid driving member 3. Since the displacement output member 2 is connected to the pair of guiding fixed members 4, and the end of each guiding fixed member 4 is fixed, the displacement output member 2 is limited to move up and down within a small range. As can be seen from FIG. 6, the displacement relationship between a displacement direction and the direction of the force is:

$$\frac{δ z}{δ x} = \frac{1 - cos α}{sin α}$$

wherein, δ_{Z} is a displacement change of the displacement output member 2, δ_{X} is a displacement change of the rigid driving member 3, α is a corresponding angle when the displacement of the displacement output member 2 is δ_{X}.

Heretofore, the embodiments of the present disclosure have been described in detail in conjunction with the accompanying drawings. It should be noted that the implementations that are not shown or described in the drawings or the text of the specification are all known to those of ordinary skill in the art and are not described in detail. In addition, the above definitions of the various elements and methods are not limited to the specific structures, shapes or manners mentioned in the embodiments, and those skilled in the art can simply modify or replace them.

Based on the above description, those skilled in the art should have a clear understanding of the flexible hinge structure of the present disclosure.

In summary, the present disclosure provides a flexible hinge structure in which the drive block is connected to the displacement block by 90 degrees through the flexible portions. Since the flexible portions are elastically deformable, the displacement in the output direction is at an angle of 90 degrees to the displacement in the driving direction. There is no linkage mechanism for transmitting force in the structure, and the driving member is directly connected to the displacement output member through the flexible portions, therefore the structure is compact and the response is fast. For example, in an exposure system, the precision optical lens may be axially adjusted conveniently from outside. In addition, the side of input displacement is proportional to the size of the output displacement to zoom in or zoom out, which is similar to a differential mechanism, and it is easier to achieve precise control.

It should also be noted that the directional terms mentioned in the embodiments, such as “upper”, “lower”, “front”, “back”, “left”, “right”, etc., are only referring to the directions of the drawings, it is not intended to limit the scope of protection of the present disclosure. Throughout the drawings, the same elements are denoted by the same or similar reference numerals. Conventional structures or configurations will be omitted when it may cause confusion to the understanding of the present disclosure.

Further, the shapes and sizes of the components in the drawings do not reflect the true size and proportion, but merely illustrate the contents of the embodiments of the present disclosure. In addition, any reference signs placed between parentheses should not be construed as a limitation.

Unless it is known to the contrary, numerical parameters in the present specification and the appended claims are approximations, and may vary depending upon the desired characteristics obtained through the contents of the disclosure. In particular, all numbers expressing the content, reaction conditions, and the like, which are used in the specification and claims, should be understood as being qualified by the term “about” in all cases. In general, the meaning of its expression is meant to encompass a variation of a particular amount within ±10% in some embodiments, a variation within ±5% in some embodiments, a variation within ±1% in some embodiments, a variation within ±0.5% in some embodiments.

Further, the word “comprising” does not exclude the presence of the elements or the steps that are not recited in the claims. The word “a” or “an” before the element does not exclude the presence of multiple such elements.

Ordinal numbers such as “first,” “second,” “third,” and the like are used in the description and claims to the qualify a corresponding component. It does not mean that the component has any ordinal number, nor does it represent the order of one component and another component, or the order of the manufacturing method. These ordinal numbers is only used to enable a component having a certain name to be clearly distinguished from another component having the same name.

In addition, the order of the above steps is not limited to the above, and may be varied or rearranged depending on the desired design, unless specifically described or necessarily occurring in sequence. The above embodiments may be used in combination with each other or with other embodiments based on design and reliability considerations, that is, the technical features in different embodiments may be freely combined to form more embodiments.

Similarly, it should be noted that, in order to simplify the present disclosure and to help understand one or more of the various disclosed aspects, in the above description of the exemplary embodiments of the present disclosure, various features of the present disclosure are sometimes grouped together into a single embodiment, figure, or description thereof. However, the disclosed method should not be interpreted as reflecting the following intent that the claimed invention requires more features than those explicitly recited in each claim. More specifically, as reflected in the following claims, the disclosed method has less features than a single embodiment disclosed above.

The purpose, technical solutions and beneficial effects of the present disclosure are further described in detail in the specific embodiments of the present disclosure. It is to be understood that the foregoing description is only illustrative of the embodiments of the present disclosure, and is not intended to limit the scope of the disclosure, any modifications, equivalent substitutions, improvements, etc., made within the spirit and scope of the present disclosure should be included within the scope of the present disclosure.

1. A flexible hinge structure, comprising:
a rigid driving member;
a mounting fixed member which is connected to an upper surface of the rigid driving member through a first flexible portion at one end in a longitudinal direction of the upper surface, a first fixing structure being provided on a surface of the mounting fixed member;
a displacement output member connected to the upper surface of the rigid driving member through a second flexible portion at the other end in the longitudinal direction of the upper surface; and
a pair of guiding fixed members symmetrically disposed on both sides of the displacement output member through third flexible portions, the both sides being parallel to the longitudinal direction of the upper surface of the rigid driving member, and a second fixing structure being provided on a surface of each of the guiding fixed members.

2. The flexible hinge structure according to claim 1, wherein the mounting fixed member is composed of at least two first rigid blocks, first rigid blocks are connected to one another through a fourth flexible portion, and the first fixing structure is disposed on a surface of an outermost first rigid block.

3. The flexible hinge structure according to claim 2, wherein the displacement output member is composed of at least two second rigid blocks, and the second rigid blocks are connected to one another through a fifth flexible portion.

4. The flexible hinge structure according to claim 3, wherein each of the guiding fixed members is composed of at least two third rigid blocks, the third rigid blocks are connected to one another through a sixth flexible portion, and the second fixing structure is disposed on a surface of an outermost third rigid block.

5. The flexible hinge structure according to claim 4, wherein the first flexible portion, the second flexible portion, the fourth flexible portion, and the fifth flexible portion are parallel to each other.

6. The flexible hinge structure according to claim 4, wherein a longitudinal direction of each of the first flexible portion, the second flexible portion, the fourth flexible portion and the fifth flexible portion is perpendicular to a longitudinal direction of the mounting fixed member.

7. The flexible hinge structure according to claim 4, wherein the sixth flexible portion is parallel to the third flexible portion.

8. The flexible hinge structure according to claim 4 or 7, wherein a longitudinal direction of each of the sixth flexible portion and the third flexible portion is parallel to a longitudinal direction of the mounting fixed member.

9. The flexible hinge structure according to claim 8, wherein each of the first flexible portion, the second flexible portion, the third flexible portion, the fourth flexible portion, the fifth flexible portion and the sixth flexible portion has a cross section of an I-shape or a circular arc shape.

10. The flexible hinge structure according to claim 1, wherein each of the first fixing structure and the second fixing structure comprises at least a mounting hole.

11. The flexible hinge structure according to claim 5, wherein a longitudinal direction of each of the first flexible portion, the second flexible portion, the fourth flexible portion and the fifth flexible portion is perpendicular to a longitudinal direction of the mounting fixed member.

12. The flexible hinge structure according to claim 7, wherein a longitudinal direction of each of the sixth flexible portion and the third flexible portion is parallel to a longitudinal direction of the mounting fixed member.
